(19) United States
(12) Patent Application Publication
(10) Pub. No.: US 2014/0169055 A1
(43) Pub. Date: Jun. 19, 2014

(54) NON-ISOLATED DC/AC INVERTER

(71) Applicant: Enphase Energy, Inc., Petaluma, CA (US)

(72) Inventor: Martin Fornage, Petaluma, CA (US)

(73) Assignee: Enphase Energy, Inc., Petaluma, CA (US)

(21) Appl. No.: 14/132,562

(22) Filed: Dec. 18, 2013

Related U.S. Application Data
(60) Provisional application No. 61/738,739, filed on Dec. 18, 2012.

(51) Int. Cl. H02M 7/5387

(52) U.S. Cl. CPC H02M 7/53871
USPC 363/132

(57) ABSTRACT

A method and apparatus for converting DC power comprising: a boost circuit comprising two switches and a capacitor where the two switches are serially connected and coupled in parallel to the capacitor, a voltage source inverter (VSI) comprising at least four switches in an H-bridge configuration, and a controller coupled to the boost circuit and VSI for selectively energizing the switches wherein no more than two switches are toggling in a time period for operating the apparatus in either the buck mode or boost mode.

### CROSS-REFERENCE TO RELATED APPLICATION

This application claims priority to U.S. Provisional Patent Application No. 61/738,739 filed on Dec. 18, 2012, which is incorporated by reference herein in its entirety.

### BACKGROUND

1. Field of the Invention

Embodiments of the present invention generally relate to power conversion techniques and, more particularly, to a non-isolated power converter.

2. Description of the Related Art

Distributed power systems typically comprise a power source that generates direct current (DC) power, a power converter, and a controller. The power source may be a solar panel or solar panel array, a wind turbine or a wind turbine array, a hydroelectric generator, fuel cell, and the like. The power converter converts the DC power into alternating current (AC) power, which may be coupled directly to the AC power grid. The controller monitors and controls the power sources and/or power converter to ensure that the power conversion process operates as efficiently as possible.

One type of power converter is known as a micro-inverter. Micro-inverters typically convert DC power to AC power at the power source. Thus, each power source is typically coupled to a single micro-inverter. A plurality of AC power outputs from the micro-inverters are coupled in parallel to the AC power grid. Since the outputs of each micro-inverter are coupled in parallel directly to the AC power grid, all the parallel connected micro-inverters are simply synchronized to the AC voltage of the AC power grid. Because of the parallel connected nature of a parallel connected micro-inverter system, the output voltage of each micro-inverter is substantial, e.g., hundreds of volts.

Consequently, the micro-inverters are typically buck-boost type inverters with an H-bridge output circuit that require a transformer to generate the high-voltage and switching transistors to handle the high-voltage within the H-bridge to produce the AC wave form. The transformer and high-voltage transistors add significant cost to the manufacturing cost of a micro-inverter. Furthermore, the switches for boost and buck operations are constantly switching during a power conversion operation as conventional boost circuits maintain a static voltage output and buck circuits can only lower voltages, the combination of which, leads to wasteful switching losses.

The losses are detrimental to efficiency as it is critical that the DC power generated and effectively converted to match the intended load, e.g., the AC grid. The control of the micro-inverters by switching transistors can grow complex, and consume power that could otherwise be beneficially contributed to the AC power grid.

Thus, there is a need in the art for a distributed power system that requires minimal switching during the conversion of DC power to AC power for the power grid.

### SUMMARY

Embodiments of the present invention generally relate to a method and apparatus providing a non-isolated power converter substantially as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic diagram of one exemplary embodiment of a non-isolated DC/AC inverter with buck/boost capabilities in accordance with one or more embodiments of the present invention;

FIG. 2 depicts an exemplary timing diagram of the inverter switch operation for selective buck-boost capability in accordance with one or more embodiments of the invention;

FIG. 3 is a flow diagram of an exemplary method for operating the non-isolated DC/AC inverter in a buck or boost mode in accordance with one or more embodiments of the present invention; and

FIG. 4 is a block diagram of a system for power conversion in accordance with one or more embodiments of the present invention.

### DETAILED DESCRIPTION

Embodiments of the present invention relate to a power inverter that operates to advantageously reduce switching losses by selectively controlling operation in a boost mode or a buck mode when necessary. In other words, boosting (i.e., increasing) an input DC voltage only when needed, and not bucking (i.e., decreasing) the voltage. Alternatively, embodiments also only bucking the input voltage and not boosting the input voltage. Switching losses are reduced and allows for higher switching frequency since fewer switches are actively toggling. In turn, the higher switching frequency that leads to smaller reactive component sizes and a decrease in the electronics physical volume.

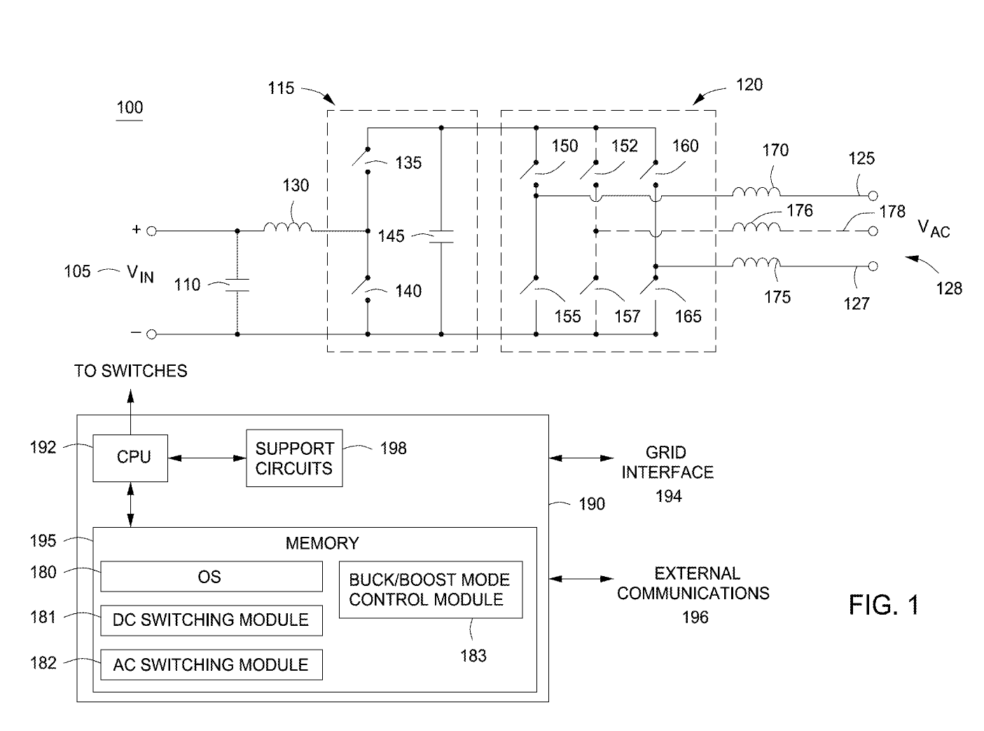

FIG. 1 depicts a schematic diagram of one exemplary embodiment of a non-isolated DC/AC inverter 100 with buck/boost capabilities. The DC/AC inverter 100 is said to be non-isolated because no transformer is required for the power conversion. The inverter 100 may operate within any application where DC power is to be converted into AC power.

The inverter 100 comprises DC input port 105 from a distributed power module (e.g., a solar panel) connected to a first capacitor 110, a first inductor 130, a second capacitor 145 (operating as a DC link), a boost circuit 115, a voltage source inverter (VSI) 120, and finally to an AC output port 128. In some embodiments, common mode noise may be reduced at the DC input port 105 using H5 filtering or HERIC topology applied as filtering techniques.

The boost circuit 115 comprises a switch 135 and a switch 140 coupled across the second capacitor 145 and to the DC input via the first capacitor 110 and first inductor 130. The second capacitor 145 is connected to the VSI 120. The first inductor 130 coupled between the switches 135 and 140. The first inductor 130 supplying DC power from the DC input port 105. The boost circuit 115 and the second capacitor 145 outputs a high frequency waveform (e.g., bipolar square wave) that is coupled to the VSI 120.

The second capacitor 145 is comparatively of a smaller value (e.g., nanofarads (nF) to microfarads (μF)), than the larger first capacitor 110 (e.g., 100 μF to 100 millifarads (mF)). The first capacitor 110 and the first inductor 130 performs a bypass function and filters the DC input port 105 of power ripple that is twice the frequency of the signal at the AC output port 128. The first inductor 130 (e.g., 1 microhenry (μH) to 1 millihenry (mH)) resists current volatility combined with the first capacitor 110 forming a low pass filter at the DC input port 105 for the boost circuit 115.

The voltage on the second capacitor 145 is time variable and has a maximum voltage between Vᵢₙ at the DC input 105 and absolute value of the voltage V_{AC} at the AC output 128 (i.e., max(Vᵢₙ, Abs(V_{AC})). The second capacitor 145 stores excess energy from the DC input port 105 for subsequent use in a boost mode operation. In some embodiments, the bypass function to filter out the ripple voltage occurs at the DC input port 105 before reaching the second capacitor 145 by placement of the first capacitor 110 across the DC input port 105.

In some embodiments, the switches in the inverter 100 may be transistors switched at 3 KHz to 10 MHz and ultimately operated by a controller 190. The transistors may be any other suitable electronic switch, such as junction gate field effect transistors (JFET), metal-oxide-semiconductor controlled thyristors (MCT), insulated gate bipolar transistors (IGBTs), bipolar junction transistors (BJTs), p-type MOSFETs, gate turnoff thyristors (GTOs), and the like.

The VSI 120 comprises switches 150, 155, 160, and 165; a second inductor 170, and a third inductor 175. The second inductor 170 located between switch 150 and fourth switch 155 to form a first leg 125 of the AC output port 128. The third inductor 175 located between switch 160 and switch 165 to form a second leg 127 of the AC output port 128. In some embodiments, the VSI 120 is in an H-Bridge configuration.

Alternative embodiments for a multi-phase output of the VSI 120, include a fourth inductor 176 between a seventh switch 152 and an eighth switch 157 to form a third leg of the AC output port 128. Further still are embodiments coupling a capacitor to each leg of the AC output port 128 for smoothing an AC signal.

In operation, the voltage V_{IN} at the DC input port 105 is compared to V_{AC} at the AC output port 128. The voltages may be sampled by respective voltage samplers, voltage detectors (not shown) as well as current by current samplers (not shown) or the like to couple data for analysis by the controller 190. In alternative embodiments, the voltage samplers may also include analog to digital conversion circuitry to couple digital data to the controller 190. The instantaneous output voltage is represented by V_{AC} and in some embodiments is an AC commercial grid.

In some embodiments, operation for controlling the VSI 120 output to the AC output power 128 includes using pulse width modulation (PWM) on both legs (e.g., 125 and 127). In other embodiments, one leg may be switched at a given frequency and the other leg at the grid frequency. For example, switch pair 150/155 may be switched at 100 KHz for the first leg 125 and switch pair 160/165 may be switched at 60 Hz for the second leg 127. In such an example, only one inductor is located on the high frequency leg (e.g., first leg 125) and not the slower leg (e.g., second leg 127).

Further embodiments may include a third output leg 178 and corresponding inductor 176 for three phase AC output. In such an embodiment, for three phase conversion, four or six switches (150, 152, 155, 157, 160, or 167) will be active at the same time as two of the AC output legs (lines 125 and 127) and the VSI 120 will buck when the boost circuit 115 operates. In addition, conventional third harmonic injection, can be used to further reduce the amount of required switching.

The depicted switches may be transistors controlled by the controller 190. The controller 190 comprises a CPU/processor 192, support circuits 198, and memory 195 containing instructions and algorithms. The CPU 192 processing inputs and outputs to the transistors/switches. Other embodiments may include external communications 196 (i.e., gateway) and a grid interface 194. Alternative embodiments may use control algorithms on a custom Application Specific Integrated Circuit (ASIC). The controller 190 determines the switching of the switches 135, 140, 150, 155, 152, 157, 160, and 165 using modules stored in memory 195. The memory 195 comprises an operating system 180, a DC switching module 181, an AC switching module 182, and buck/boost mode control module 183. Alternative embodiments for the controller 190 may use a state machine, microcontroller, hysteretic controller, lookup table controller, and pulse width modulator.

The operating system 180 facilitates executing commands between the CPU 192 and memory modules. The DC switching module 181 controls the switches 135 and 140 of the boost circuit 115. The AC switching module 182 controls the operation of switches 150, 152, 155, 157, 160, and 165 to output an AC power at the AC output port 178.

The buck/boost mode control module 183 contains instructions to operate the DC and AC switching modules 181 and 182 such that the inverter 100 operates in either a boost mode or a buck mode. The buck/boost mode control module 183 determines the operating state by analyzing the value of the voltage V_{IN} at the DC input port 105 as compared with the voltage V_{AC} of the AC waveform at the AC output port 128. In some embodiments, the voltage V_{AC} represents the voltage of the AC signal output by the inverter 100. In other embodiments, the voltage V_{AC} is the voltage of the AC line when the AC output port 128 is coupled to an AC commercial power grid.

For buck mode, the voltage V_{IN} is greater than the output voltage V_{AC} and the voltage V_{IN} need not be boosted to a higher voltage level. The voltage V_{IN} at the DC input port 105 is compared to the absolute value of the magnitude of the output voltage V_{AC}. In buck mode operation, the boost circuit 115 does not toggle or actively switch (e.g., using PWM) but rather holds the switch 140 in an open position and the switch 135 in a closed position to charge the second capacitor 145. The second capacitor 145 is charged to bypass a boost function and proceed to the inversion operation of the VSI 120 such that switch 150 and switch 155 in the VSI 120 pulse width modulate the DC power to create AC power. Switch 160 is open and switch 165 closes to send the converted AC power to the third inductor 175 and ultimately the AC output line 127.

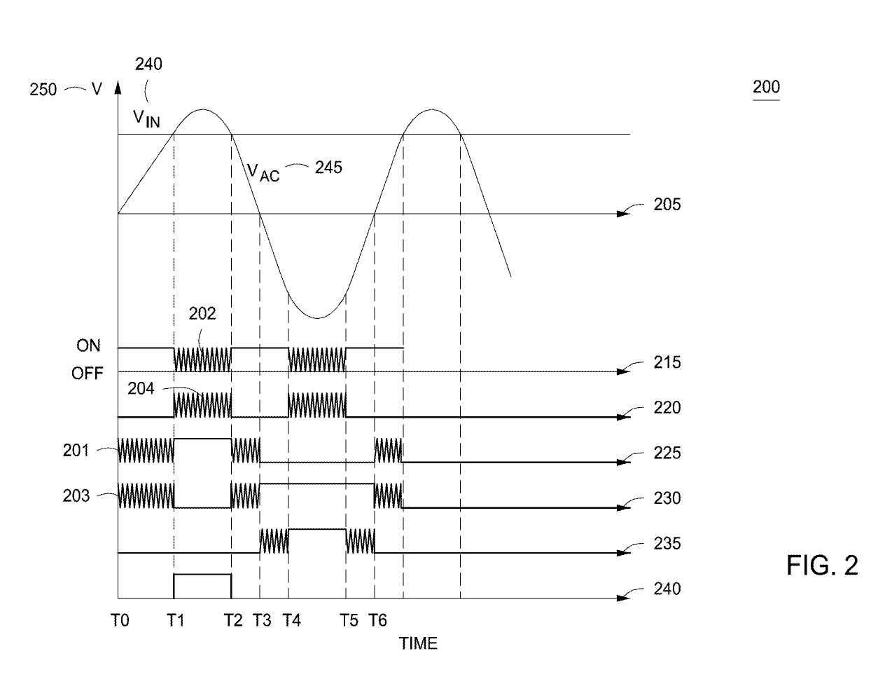

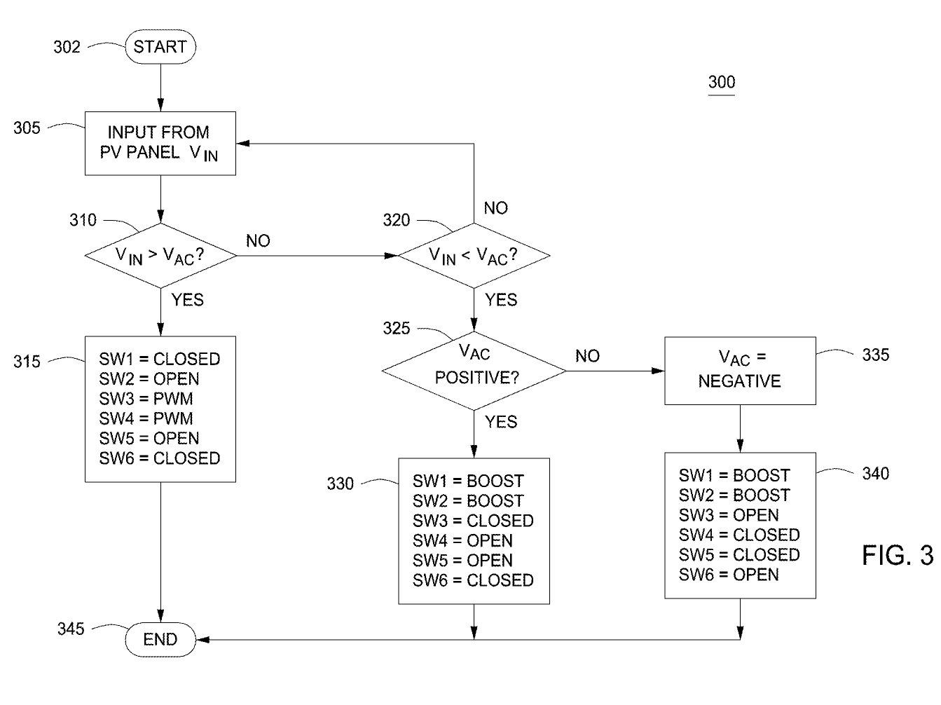

During times where the voltage at DC input 105 is less than the positive magnitude of the AC output (125 and 127), the inverter 100 operates in a boost mode. The time periods typically occurring at the peaks of the output waveform as shown in FIG. 2. The inverter 100 has a configuration such that the first capacitor 110 and first inductor 130 forms a low pass filter on the DC input 105. The incoming current from the first inductor 130 is boosted up to a necessary voltage value (e.g., the difference between V_{IN} and V_{AC}) in the second capacitor 145 for input to the VSI 120 using the first and second switches (135 and 140). The third, fourth, fifth, and sixth switches (elements 150, 155, 160, and 165) of the VSI 120 are turned on and off depending on the polarity of the output voltage V_{AC} (shown as lines 125 and 127) to correspond with the grid cycle. As will be discussed further below, FIGS. 2 and 3 describe the timing operation of the switches based on power input. The switching between either a buck or boost mode operation depends on when a buck or boost of the voltage V_{IN} is required, and in some embodiments changes will occur four times per grid cycle.

FIG. 2 depicts an exemplary timing diagram 200 of the inverter switch operation for selective buck-boost capability in accordance with one or more embodiments of the invention. FIG. 2 depicts a plot of voltage 250 versus time 205 and depicts the grid cycle output V_{AC} waveform cycle 245 compared to the input DC voltage V_{IN} waveform 240 received by the VSI 120 with respect to the switches in the exemplary inverter 100.

The timing diagram 200 further comprises signals lines 215, 220, 225, 230, 235, and 240 corresponding to control signals for switches 135, 140, 150, 155, 160, and 165. Diagram 200 describes an embodiment wherein the VSI 120 has a single phase output and thus switches 150, 155, 160, and 165. Alternative embodiments include optional switches 152 and 157 for three phase output.

The first and second switch states (signals 215 and 220) for boost capability are reversed (i.e., the switch 140 is off when the switch 135 is on). Pulse waveform trains 202, 204 for switches 135 and 140 depict a toggling of the switches for PWM when a boost of the V_{IN} is necessary. Other pulse waveform trains in signal lines 225, 230, and 235 (which depict switch states for switches 150, 155, 160) depict PWM of respective switches between ON/OFF holding periods. Thus, from the timing diagram 200, no more than two switches are actively switching (i.e., toggling) for a given period of time while the remaining switches are held in a constant on or off position.

FIG. 2 begins at time period T0 to T1. From time period T0 to T1, the input voltage 240 is greater than the output voltage waveform cycle 245. Accordingly, switch 135 is held in an “ON” position or closed as to couple DC power from the DC input port to charge the second capacitor and to the VSI 120. Switches 150 and 155 of the VSI 120 are actively switched with pulse width modulation (PWM) 201 and 203 to generate AC power without boost mode operation. From T0 to T1, since operation of the VSI 120 cannot increase the voltage output of the inverter 100, the inverter 100 may be viewed as in a buck mode operation.

From period T1 to T2, the inverter 100 is in a boost mode operation. Boost mode operation occurs when output voltage V_{AC} cycle 245 is greater than V_{IN}. Switches 135 and 140 accordingly toggle with PWM 202 and 204. Switch 150 and switch 165 are held in an ON position (shown as signals 225 and 240) while the switch 155 and switch 160 are held in an off position. From time period T2 to T3, switch operation is similar to that of period T0 to T1 for a buck mode operation.

From period T3 to T4, the inverter is in a buck mode operation outputting a falling edge of the AC waveform of V_{AC} cycle 245. Switches 140, 150, and 165 are OFF (shown as signals 220, 225, and 240) and the switches 135 and 150 are held in an ON position (shown as 215 and 230). In period T3 to T4, only the switch 160 is actively switching to output a portion of the cycle.

From period T4 to T5, switches 135 and 140 use PWM for the boost mode operation. Switches 150 and 165 are held in an OFF position and switches 155 and 160 are held in an ON position. Since this period corresponds to when the V_{AC} cycle 245 is negative, the switch operation of remaining switches 150, 155, 160, 165 are reversed as compared to period T1 to T2.

From period T5 to T6, a buck mode operation similar to period T3 to T4 to bypass any boosting functions and generate the remainder of the V_{AC} cycle 245. Only switch 160 is actively toggled V_{AC} cycle 245. Thus, from the timing diagram 200, no more than two switches of the inverter 100 are actively toggled at any given time, thereby reducing switching losses.

Switches may be transistors and, in some embodiments, can be controlled by the controller 190. In further embodiments, the timing of the switches may be determined by a state machine or a look up table (LUT). In alternative embodiments, modulation of the DC waveform 240 can be achieved with the switches besides by pulse width modulation, such as hysteretic control, or predictive control. Detection of the input and output power may use support circuitry (not shown) comprising current sensors, voltage meters, and the like.

FIG. 3 is a flow diagram of an exemplary method 300 for operating the non-isolated DC/AC inverter in a buck or boost mode in accordance with one or more embodiments of the present invention. The method 300 is implemented by the inverter 100 and executed using the controller 190. The method 300 is described with respect to a DC source such as a PV panel or PV module. In alternative embodiments, other forms of distributed generators (e.g., wind turbines, steam generators and the like) or DC sources (e.g., batteries and the like) may be used in place of the PV panel.

The method 300 begins at step 302 and proceeds to step 305 where an input voltage from the DC source is received and represented as value V_{IN}. The input voltage value V_{IN} is then compared to the output voltage at step 310. The output voltage value in some embodiments may be the AC grid voltage represented by V_{AC}. The next steps of the method 300 determine whether to operate with a buck or boost capability.

If V_{IN} is greater than V_{AC}, a buck mode operation is required and the method 300 proceeds to step 315 performing an exemplary associated switching procedure for buck mode operation. Specifically, in step 315, the switch 135 (SW1) is closed, the switch 140 (SW2) is open and DC power is coupled from the DC input port 105 without boosting. Switch 150 (SW3) performs pulse width modulation with switch 155 (SW4) to output an AC power. Switch 160 (SW5) is opened, and switch 165 (SW6) is closed. Such a switching procedure indicates the inverter 100 only operates in the buck mode operation when V_{IN} is greater than V_{AC}. However, if V_{IN} is not greater than V_{AC}, the method 300 proceeds to step 320. Step 320 determines when V_{IN} is less than V_{AC} such that a boost mode situation is required otherwise, the method 300 reverts back to taking in DC input.

In situations where V_{IN} is less than V_{AC}, the boost mode operation is executed using the boost circuit 115. At step 325 determines whether the instantaneous V_{AC} is positive or negative. When it is determined V_{AC} is a positive value, the method proceeds to step 330. Step 330 comprises an exemplary associated boost mode switching procedure. The procedure includes operating switch 135 (SW1) and switch 140 (SW2) to boost with the energy stored (i.e., discharging the second capacitor 145) to generate a requisite voltage for the VSI 120. The boosting operation includes toggling switches 135 and 140 using timing determined by the buck/most mode control module 183. In some embodiments, the timing of the toggling is determined by the harmonic frequency of the inverter 100. The switching operation also ensures switch 150 (SW3) is closed, switch 155 (SW4) is opened, switch 160 (SW5) is opened, and switch 165 (SW6) is closed. In some embodiments, the requisite voltage is the maximum possible output voltage from the boost circuit 115. Thus, step 330 represents only a boost mode operation when V_{IN} is less than the value of V_{AC}.

When determined at step 325 that V_{AC} is a negative value, the method 300 proceeds to step 335 and then to step 340. Step 340 comprises an exemplary associated boost mode operation for the negative portion of the AC cycle. Step 340 includes the switch 135 (SW1) and switch 140 (SW2) are boosting the second capacitor to a requisite voltage for the VSI 120, switch 150 (SW3) is opened, switch 155 (SW4) is closed, switch 160 (SW5) is closed, and switch 165 (SW6) is opened. The boosting operation includes toggling switches 135 and 140 using timing determined by the buck/most mode control module 183. Thus, step 330 represents only a boost mode operation when V_{IN} is less than the absolute value of V_{AC}. The method 300 then ends at step 345. As further shown in the aforementioned embodiment, no more than two switches of the VSI 120 are active at a given time window, thus reducing switching losses. In alternative embodiments, a three phase output is implemented by the VSI circuit 120 with a third output leg 178 at the AC output port 128.

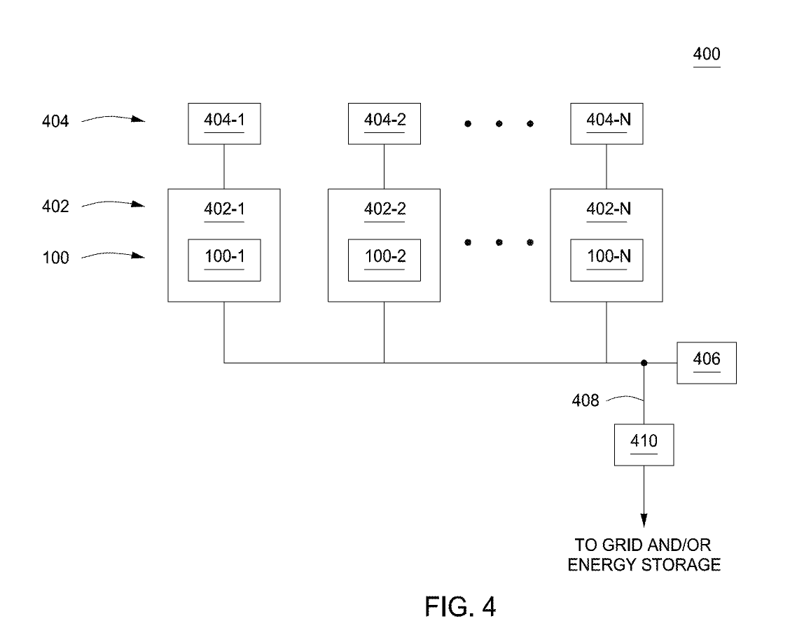

FIG. 4 is a block diagram of a system 400 for power conversion comprising one or more embodiments of the present invention. This diagram only portrays one variation of the myriad of possible system configurations and devices that may utilize the present invention. The present invention can be utilized in any system or device that uses an inverter for DC-AC or AC-DC power conversion with buck-boost operation.

The system 400 comprises a plurality of power converters 402-1, 402-2 . . . 402-N, collectively referred to as power converters 402; a plurality of DC power sources 404-1, 404-2 . . . 404-N, collectively referred to as DC power sources 404; a system controller 406; a bus 408; and a load center 410. The DC power sources 404 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power.

Each power converter 402-1, 402-2 . . . 402-N is coupled to a single DC power source 404-1, 404-2 . . . 404-N, respectively; in some alternative embodiments, multiple DC power sources 404 may be coupled to a single power converter 402, for example a single centralized power converter 402. The power converters 402-1, 402-2 . . . 402-N comprise the inverters 100-1, 100-2 . . . 100-N, respectively utilized during power conversion. Each of the inverters 100-1, 100-2 . . . 100-N employs the three-port operating technique previously described with bulk energy storage formed at an internal third port in inverter 100. In some embodiments, the power inverters 402 may generate a single phase AC power output; in other embodiments, the power converters 402 may generate a split-phase or three-phase AC output.

The power converters 402 are coupled to the system controller 406 via the bus 408. The system controller 406 is capable of communicating with the power converters 402 by wireless and/or wired communication (e.g., power line communications) for providing operative control of the power converters 402. The power converters 402 are further coupled to the load center 410 via the bus 408.

The power converters 402 are each capable of converting the received DC power to AC power, although in other embodiments the power converters 402 may receive an AC input and convert the received input to a DC output. The power converters 402 couple the generated output power to the load center 410 via the bus 408. The generated power may then be distributed for use, for example to one or more appliances, and/or the generated energy may be stored for later use, for example using batteries, heated water, hydro pumping, H₂O-to-hydrogen conversion, or the like. In some embodiments, the power converters 402 convert the DC input power to AC power that is commercial power grid compliant and couple the AC power to the commercial power grid via the load center 410.

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is defined by the claims that follow.

1. An apparatus for converting DC power comprising:
a boost circuit comprising two switches and a capacitor where the two switches are serially connected and coupled in parallel to the capacitor;
a voltage source inverter (VSI) comprising at least four switches in an H-bridge configuration; and
a controller coupled to the boost circuit and VSI for selectively energizing the switches wherein no more than two switches are toggling in a time period for operating the apparatus in either the buck mode or boost mode.

2. The apparatus of claim 1, wherein selection of the at least two switches for toggling is based on a comparison of an input voltage to the boost circuit and output voltage from the VSI.

3. The apparatus of claim 1, wherein the two toggling switches are energized using at least one of: pulse width modulation, predictive control, or hysteretic control.

4. The apparatus of claim 1, wherein the remaining switches are not toggling and held at either a closed or open position.

5. The apparatus of claim 1, further comprising a DC input port for receiving DC power for conversion to AC power.

6. The apparatus of claim 5, further comprising a low pass filter circuit at the DC input port.

7. The apparatus of claim 5, wherein when the apparatus is in a buck mode, no more than two active switches are active, and located within the inverter circuit.

8. The apparatus of claim 5, wherein when the apparatus is in the boost mode, no more than two active switches are active, and located within the boost circuit.

9. The apparatus of claim 1, wherein the apparatus is capable of outputting multiphase power.

10. The apparatus of claim 9, wherein outputting multiphase power further comprises three output legs.

11. A method for converting DC power using a converter comprising:
selectively operating two switches of a boost circuit to control charging a capacitor of a boost circuit when DC input power is greater than AC output power;
coupling power from the boost circuit to a voltage source inverter (VSI) comprising four switches in an H-bridge configuration; and
operating the boost circuit and VSI with a controller, wherein no more than two switches are toggling in a time period for operating the apparatus in either the buck mode or boost mode.

12. The method of claim 11, wherein selection of the at least two switches for toggling is based on a comparison of an input voltage to the boost circuit and output voltage from the VSI.

13. The method of claim 11, wherein the two toggling switches are energized using at least one of: pulse width modulation, predictive control, or hysteretic control.

14. The method of claim 11, wherein the remaining switches are not toggling and held at either a closed or open position.

15. The method of claim 11, wherein the method further comprising receiving DC input power for conversion to AC output power.

16. The method of claim 13, wherein the DC input power is received at a DC input port further comprising a low pass filter.

17. The method of claim 15, further comprising when operating in a buck mode, no more than two switches actively toggling are located within the inverter circuit.

18. The method of claim 15, further comprising when operating in a boost mode, no more than two switches actively toggling are located within the boost circuit.

19. The method of claim 11, wherein the VSI is capable of outputting multiphase power.

20. The method of claim 19, wherein outputting multiphase power includes outputting to three output legs.
